(19) United States
(12) Patent Application Publication
(10) Pub. No.: US 2010/0309375 A1
(43) Pub. Date: Dec. 9, 2010

(54) INDEPENDENT MANAGEMENT OF INDIVIDUAL ELEMENTS OF A GRAPHICAL DISPLAY

(75) Inventor: Michael Thomas Alexander, Denver, CO (US)

Correspondence Address: SETTER ROCHE LLP, PO BOX 780, ERIE, CO, 80516, US

(73) Assignee: EchoStar Technologies, LLC, Englewood, CO (US)

(21) Appl. No.: 12/480,936

(22) Filed: Jun. 9, 2009

(51) Int. Cl. H04N 5/50

(52) U.S. Cl. 348/570; 348/E05.097

(57) ABSTRACT

A method of managing a graphical display incorporating individual graphical elements is presented. In the method, a data set is created for each of the graphical elements, wherein each of the data sets describes a graphical feature of the associated graphical element. A separate function is associated with each of the data sets, wherein each of the functions is configured modify the data set of the associated graphical element to alter a graphical feature of the associated graphical element. A signal influencing the graphical display is generated. In response to the signal, the function associated with each of at least one of the data sets is initiated. The graphical display is transferred to an output device for viewing by a user.

### BACKGROUND

Many modern electronic information devices relay visual information to a user of the device by way of a visual output device, such as a video monitor, liquid crystal diode (LCD) display, or a similar component. Further, with technological advances in the resolution and overall optical quality of these output devices, increasing amounts of information may be presented to the user. In one particular example, most television set-top boxes, such as cable and satellite television programming receivers and digital video recorder (DVR) devices, provide numerous types of graphical displays for relaying information to the user regarding the operation and status of the set-top box.

One such display with which set-top box users are familiar is an electronic program guide (EPG) display, which pertinent information regarding the various television programs available via the set-top box for viewing or recording. Generally, each of the programs is presented as a separate graphical element of the display. For example, information concerning the programs may be provided as a grid of graphical boxes, with each box representing a particular programming event, such as a movie, sporting event, news program, series episode, or the like. Typically, the boxes are aligned in rows according to the programming channels on which the programs are presented, and along columns according to a broadcast or presentation time for the program. The box may include text indicating at least a portion of the title of the program, and may provide additional program-related information.

Normally, a presentation of the EPG on a television or video monitor coupled to the set-top box involves several channels of programming over a period of no more than a few hours. To allow access to the remainder of the EPG, a user may navigate the EPG by way of commands issued using a remote control device to alter the range of channels and/or viewing times of the EPG graphical display being presented at a particular time.

An EPG display represents just one example of a graphical display incorporating multiple graphical display elements. A more generalized example of such a display may be a display of a computer spreadsheet, in which various cells containing numbers or text are aligned in rows and columns for calculation, presentation, and the like. Further, other types of graphical displays involving a plurality of graphical elements may not be limited to a row and column arrangement, but may involve other arrangements or distributions of graphical elements within the display.

### BRIEF DESCRIPTION OF THE DRAWINGS

Many aspects of the present disclosure may be better understood with reference to the following drawings. The components in the drawings are not necessarily depicted to scale, as emphasis is instead placed upon clear illustration of the principles of the disclosure. Moreover, in the drawings, like reference numerals designate corresponding parts throughout the several views. Also, while several embodiments are described in connection with these drawings, the disclosure is not limited to the embodiments disclosed herein. On the contrary, the intent is to cover all alternatives, modifications, and equivalents.

FIG. 1 is a simplified block diagram of an electronic device according to an embodiment of the invention.

FIG. 2 is a flow diagram of a method according to an embodiment of the invention of managing a graphical display incorporating individual graphical elements.

FIG. 3 is a block diagram of a television set-top box according to an embodiment of the invention.

FIG. 4A is a logical representation of an EPG graphical display provided by the set-top box of FIG. 3 according to an embodiment of the invention.

FIG. 4B is a logical representation of grid area of the EPG graphical display of FIG. 4A with an associated grid buffer according to an embodiment of the invention.

FIG. 5 is a logical representation of the graphical element data sets stored within the set-top box of FIG. 3 according to an embodiment of the invention.

FIG. 6 is a logical representation of data fields and corresponding methods associated with one of the data sets of FIG. 5 according to an embodiment of the invention.

FIG. 7 is a graphical representation of a grid data structure incorporating the data sets depicted in FIG. 5 according to an embodiment of the invention.

### DETAILED DESCRIPTION

The enclosed drawings and the following description depict specific embodiments of the invention to teach those skilled in the art how to make and use the best mode of the invention. For the purpose of teaching inventive principles, some conventional aspects have been simplified or omitted. Those skilled in the art will appreciate variations of these embodiments that fall within the scope of the invention. Those skilled in the art will also appreciate that the features described below can be combined in various ways to form multiple embodiments of the invention. As a result, the invention is not limited to the specific embodiments described below, but only by the claims and their equivalents.

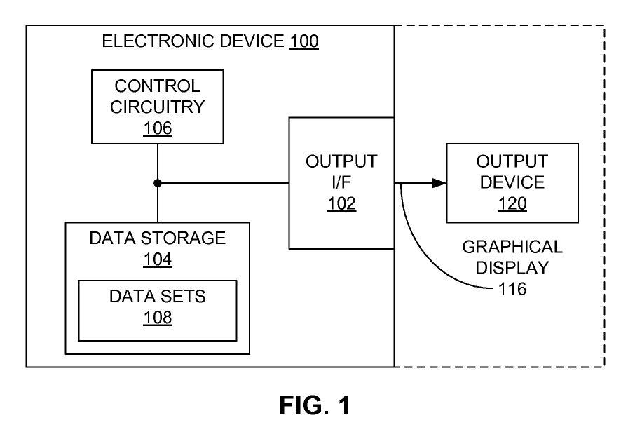

FIG. 1 is a simplified block diagram of an electronic device 100 according to an embodiment of the invention. The electronic device 100 includes an output interface 102 configured to present a graphical display 116 to an output device 120. Also included in the electronic device 100 are data storage 104 and control circuitry 106. As a result, the electronic device 100 may take any of a number of forms, such as a television set-top box, a desktop or laptop computer, a mobile communication device, or any other device capable of providing a graphical display incorporating multiple graphical elements. Each of these devices may also incorporate components other than those specifically illustrated in FIG. 1 while remaining with the scope of the invention as described below.

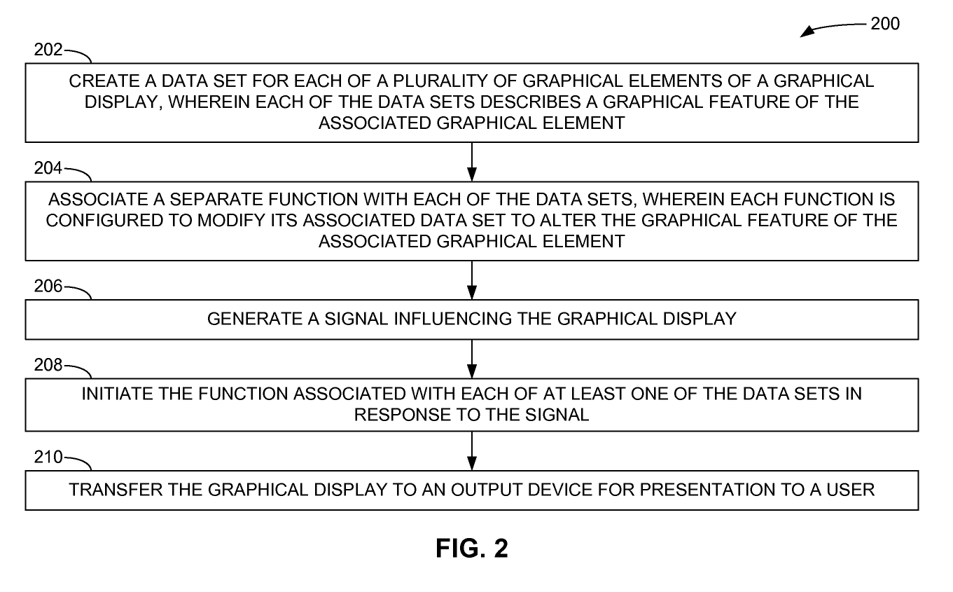

FIG. 2 presents a flow diagram of a method 200 of managing a graphical display 116 incorporating individual graphical elements in the electronic device 100 of FIG. 1 according to an embodiment of the invention. However, electronic devices other than the specific device 100 of FIG. 1 may employ the method 200 of FIG. 2 to similar effect.

In the method 200, the control circuitry 106 of the electronic device 100 creates in the data storage 104 a data set 108 for each of the graphical elements of the graphical display 116 (operation 202). Each of the data sets 108 describes a graphical feature of its associated graphical element. The control circuitry 106 associates a separate function with each of the data sets 108, wherein each function is configured to modify its associated data set 108 to alter the graphical feature of the associated graphical element (operation 204). The control circuitry 106 generates a signal influencing the graphical display 116 (operation 206). For example, the signal may indicate that one or more of the graphical elements in the graphical display 116 is to change in location, size, color, appearance, or the like. The control circuitry 106 further initiates the function associated with each of at least one of the data sets in response to the signal (operation 208). Further, the control circuitry 106 transfers the graphical display 116 by way of the output interface 102 to the output device 120 for presentation to a user (operation 210).

While the operations of FIG. 2 are depicted as being executed in a specific serial fashion, other orders of execution, including concurrent execution of two or more operations, are also possible. In one example, the transferring of the graphical display (operation 210) may occur primarily in a continuous fashion for some period of time while generation of the signal (operation 206) and initiation of the function (operation 208) may proceed during the transferring operation 210. In another embodiment, a computer-readable storage medium may have encoded thereon instructions for a processor or other control circuitry to direct various components of the device 100 of FIG. 1 to implement the method 200.

As a result of at least some embodiments of the method 200, changes in the graphical display 116 may be performed by way of each of a number of the incorporated graphical elements being modified individually by way of a separate function associated with each of the graphical elements. Such an arrangement may result in rapid implementation of desired changes in the graphical display, as well as reduced complexity in the logic required to implement such changes, compared to devices in which a single function is employed to modify the entirety of the graphical display. Other advantages may be recognized from the various implementations of the invention discussed in greater detail below.

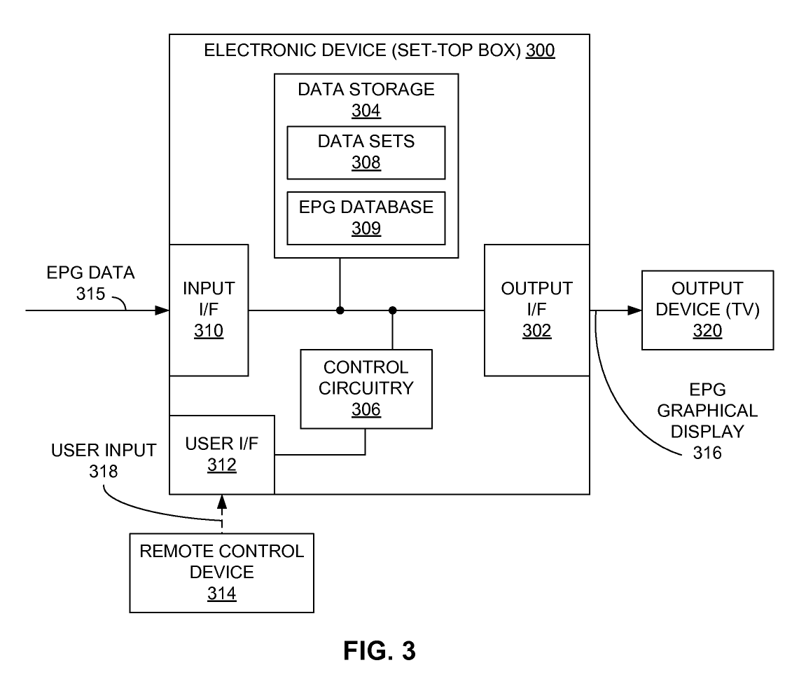

FIG. 3 is a block diagram of an electronic device 300 according to another embodiment of the invention. In this case, the electronic device 300 is a television programming set-top box or receiver 300, such as a satellite television set-top box, a cable television set-top box, a terrestrial (“over-the-air”) television set-top box, a digital video recorder (DVR), and similar devices. Such devices receive audio/video programming, such as movies, sporting events, news programs, and other forms of audio/video information and entertainment, and present the programming under the control of a user of the device. However, the set-top box 300 of FIG. 3 is employed as just one specific example of the electronic device 100 of FIG. 1 to further explicate various aspects of an embodiment of the invention, as described more fully below. Other electronic devices, such as computer systems, personal digital assistants (PDAs), mobile communication devices, and other devices presenting one or more graphical displays to a user, may benefit from application of the principles discussed in greater detail hereinafter.

The set-top box 300 includes an output interface 302, data storage 304, control circuitry 306, an input interface 310, and a user interface 312. Other components or systems, such as a DVR component, multiple tuners, and a removable storage interface, may also be incorporated within the set-top box 300, but such components are not discussed explicitly herein to simplify and focus the following discussion.

The input interface 310 is configured to receive electronic program guide data 315 from a content source, such as a television broadcast satellite or cable television headend, in addition to multiple channels of the audio/video television programming described above. The EPG data 315 includes information describing the television programming currently or subsequently being provided by the content source. This information may include a programming event (or program) identifier, title, description, programming channel, broadcast time, and other data pertaining to each of the programs or programming events that may be received at the set-top box 300 by way of the input interface 310. The input interface 310 may receive new EPG data 315 periodically so that EPG data 315 for a predetermined minimum period of time, such as the next several days, may always be available. In one embodiment, the input interface 310 may also receive updated EPG data 315 intended to replace previously-received EPG data 315. In one implementation, the EPG data 315 may be received over a communication channel separate from the channels carrying the television programming. In another example, the input interface 310 may constitute a separate interface from that employed to receive the audio/video programming.

In one embodiment, the input interface 310 receives the EPG data 315 and the television programming, and then converts the data 315 and programming to a form more usable for processing within the set-top box 300. Such conversion may include frequency down-conversion, amplification, reformatting, and other functions. In the case of a satellite set-top box 300, the input interface 310 may be coupled with or include a hyperboloid antenna combined with a low-noise block-converter/feedhorn (LNBF), which collects and amplifies the incoming signals carrying the EPG data 315 and associated audio/video programs, and down-converts the signals from microwave frequencies to intermediate frequencies. The input interface 310 may also include at least one content channel selection resource, such as a tuner or similar circuitry, for selecting one or more of the audio/video programming channels being received, descrambler circuitry for descrambling the EPG data 315 and related programming, and other circuitry.

The EPG data 315 received by way of the input interface 310 is stored at the data storage 304 in an EPG database 309 located therein. The EPG database 309 provides the information that is ultimately presented to the user in the form of an EPG graphical display 316. The data storage 304 further includes data sets 308 associated with the graphical elements of the EPG graphical display 316, the details of which are described more fully below. The data storage 304 may include any type of digital data storage medium, including solid state memory, such as static and/or dynamic random access memory (RAM) or flash memory; and direct access memory, such as magnetic and optical disk drives.

The output interface 302 of the set-top box 300 of FIG. 3 is configured to transfer the electronic program guide (EPG) graphical display 316 to an output device 320, such as a television or video monitor, in addition to the television audio/video programming mentioned above. In one implementation, the output interface 302 is configured to decode and/or convert the EPG graphical display 316 and the audio/video programming received by way of the input interface 310 for presentation to the user of the set-top box 300. For example, the EPG graphical display 316 and the video portion of the audio/video programming may be delivered by way of a modulated video cable connection, a composite or component video RCA-style (Radio Corporation of America) connection, and a Digital Video Interface (DVI) or High-Definition Multimedia Interface (HDMI) connection. The audio portion of the programming may be transported over a monaural or stereo audio RCA-style connection, or over an HDMI connection. Other audio/video formats and related connections may be employed in other embodiments.

The user interface 312 of the set-top box 300 is configured to receive user input 318 for operating the set-top box 300. In one example, the user input 318 may control the presentation and navigation of the EPG graphical display 315, as well as initiate various tasks executable by the set-top box 300 via interaction with the EPG graphical display 315. The user interface 312 may provide either or both of a control panel connection located directly on a surface of the set-top box 300, and a remote control interface. The remote control interface may receive the user input 318 from a remote control device 314 by way of commands transmitted over a radio frequency (RF) or infrared (IR) frequency band. Different communication methods, such as those employing optical or acoustic transmission of remote commands, may be used in other implementations.

The control circuitry 306 of the set-top box 300 is configured to control and interact with the input interface 310, the data storage 304, the output interface 302, and the user interface 312, based in part upon the user input 318 received by way of the user interface 312. Part of this control involves processing of the EPG database 309 and the data sets 308 located in the data storage 304, as well as generating and updating the EPG graphical display 316 based on the user input 318 and other factors. The control circuitry 306 may include one or more processors, such as a microprocessor, microcontroller, or digital signal processor (DSP), configured to execute instructions directing the processor to perform the functions discussed in greater detail hereinafter. The control circuitry 306 may also include memory or data storage adapted to contain such instructions. In another implementation, the control circuitry 306 may be strictly hardware-based logic, or may include a combination of hardware, firmware, and/or software elements.

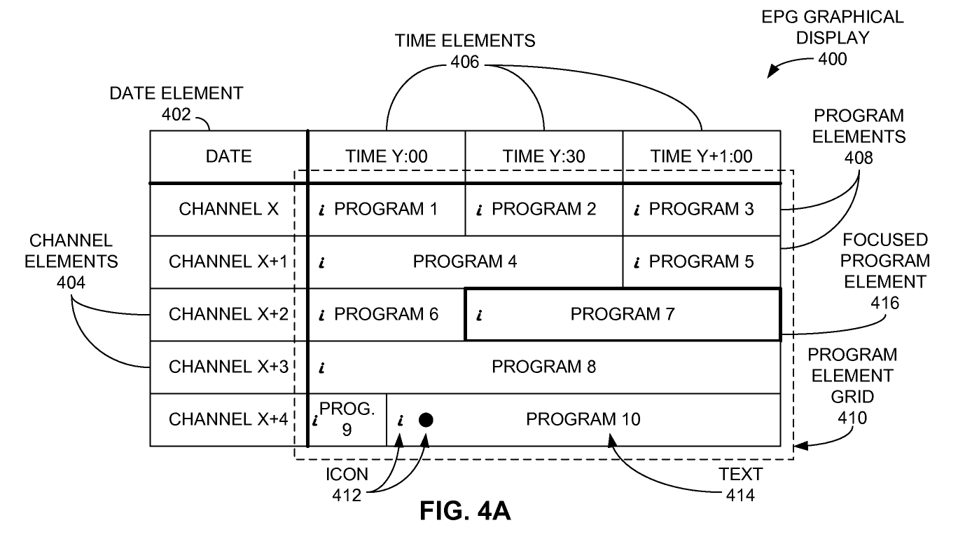

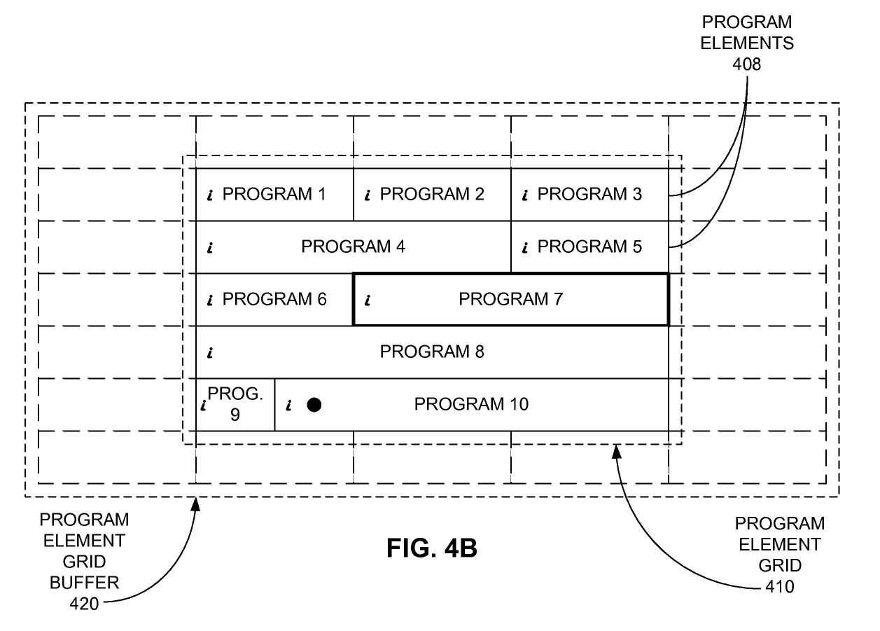

An example of the EPG graphical display 316 of FIG. 3 is depicted in FIG. 4A as an EPG graphical display 400, which presents a grid layout of audio/video programs for a number of channels scheduled to be received by the set-top box 300 over a period of time, as indicated in the EPG database 309 located in the data storage 304. In other implementations, any other type of graphical display of EPG data, such as a list of consecutive programs available on a particular channel, or a list of programs available over a number of channels at a single specific time, are also examples of an EPG graphical display 316.

Generally, the graphical display 400 incorporates multiple graphical elements, wherein each graphical element consists of a graphical box containing information to be presented to the user of the set-top box 300. For example, the upper-left corner of the graphical display 400 of FIG. 4A provides a date element 402 indicating the broadcast or presentation date of the programs whose information is currently presented in the display 400.

Located under the date element 402 is a column of channel elements 404, wherein each channel element 404 indicates the channel on which the programs listed on the same row are carried. Depending on the implementation, each of the channel elements 404 may identify the associated channel by way of a channel number, channel call letters, or both. In the specific example of FIG. 4A, the channels increase according to channel number from top to bottom. To the right of the date element 402 is a row of time elements 406 identifying a particular time period of the day identified by the date element 402 during which the programs listed directly below are available for viewing or recording, with time progressing from left to right. As a result, the channel elements 404 and the time elements 406 define a two-dimensional program element grid 410 identifying the channels and presentation times for each of the programs presented in the EPG graphical display 400.

Each of the programs identified in the graphical display 400 is represented by a separate program (or programming event) element 408 within the program element grid 410. Each of the program elements 408 visually provides identifying text information 414, such as a program title. Other information, presented in the form of one or more icons 412 or other non-textual means, may also be provided. In some situations, the icons 412 may provide a space-efficient means of relaying information regarding the status of the associated program, such as whether the set-top box 300 is configured to record the program. Other icons 412 may provide a selectable area of the program element 412 which, when selected by way of the user input 318, provides more specific information regarding the program itself, such as a description of the program, a viewer rating, a content rating, an identification of the actors involved, and other relevant information. Other graphical aspects of a program element 408, such as its color and size, may also be employed as non-textual information relating to the represented program in some examples.

Given that each program indicated by way of a program element 408 may have virtually any starting time, and may have a running time of any length, the horizontal position of the program elements 408, as well as the graphical length of those elements 408, may vary widely from element 408 to element 408, as shown in the specific example of FIG. 4A. Also, the programs represented by some of the program elements 408 may start before the earliest time indicated at the left end of the program element grid 410, and/or end beyond the right end of the grid 410.

Typically, one of the program elements 408 of the display 400 is highlighted, such as by way of a unique color or border for that element 408, to indicate a “focus” on that particular element 408. Providing focus on a program element 408 allows a user to select the focused element 408 by way of the user input 318 to access more information concerning the represented program, view the program, set a reminder to view the program, configure the set-top box 300 to record the program, or initiate some other task related to the program.

Additionally, the user may provide input 318 to change the focus from one program element 308 to another to navigate within the EPG graphical display 400. For example, such navigation may occur by way of directional keys, page-up and page-down keys, cursor manipulation, and other methods provided by the remote control device 314 for FIG. 3.

This navigation within the EPG graphical display 400 may also extend to programs and associated elements 408 not currently depicted within the program element grid 410. For example, if the user attempts to move the focus to a program element 408 off of the right end of the grid 410, the control circuitry 306 may respond by shifting the program elements 408 currently residing in the grid 410 toward the left, possibly resulting in one or more of the program elements 408 located along the left end to be removed completely. At the right end of the grid 410, program elements 408 representing programs following those programs previously represented at the right end would then be displayed at those locations in the grid 410. The time elements 406 would be shifted left in a corresponding manner. Navigation of the grid 410 by altering focus or by other means in the left, upward, and downward directions would result in the deletion, shifting, and insertion of various program elements 408 similar to that described above.

To aid in such navigation, the control circuitry 306 of the set-top box 300 may be configured to generate graphical elements 408 in advance of when the elements 408 may actually be needed for the graphical display 400. FIG. 4B provides a logical representation of the program element grid 410 of FIG. 4A in conjunction with a program element grid buffer 420 representing program elements conceptually located just beyond the currently-visible grid 410 of the graphical display 400. The program elements 408 residing in the buffer 420 (not shown explicitly in FIG. 4B) thus may be generated in advance in anticipation of those elements 408 being shifted into the visible grid 410, thus reducing latency between navigation of the display 400 requiring program elements 408 previously not residing in the visible program element grid 410 and the presentation of those elements 408 in the grid 410.

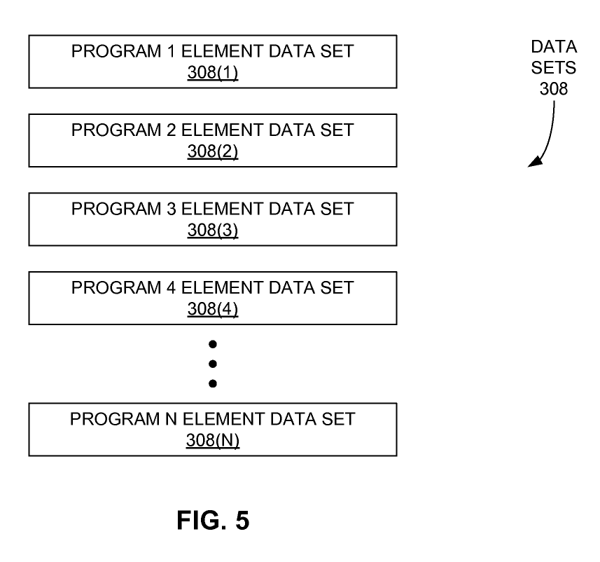

Each of the focusing, selection, and navigation aspects of the EPG graphical display 400 may be facilitated by use of the data structures or sets 308 of the data storage 304 mentioned above, in conjunction with their associated software functions or methods. FIG. 5 provides a simplified logical representation of a number of program element data sets 308, with each data set 308 representing a separate one of the program elements 408 illustrated in FIGS. 4A and 4B. In the implementation of FIG. 4B involving the use of the program element grid buffer 420, each of the program elements 408 residing within the buffer 420 may be represented by a corresponding data set 308 in the data storage 304. These data sets 308 may be aligned sequentially within the data storage 304, or may be located individually anywhere within the data storage 304. In other embodiments, any graphical element, including the date element 402, the channel elements 404, and the time elements 406, may be represented by corresponding data sets 308 and surrounding infrastructure described hereinafter.

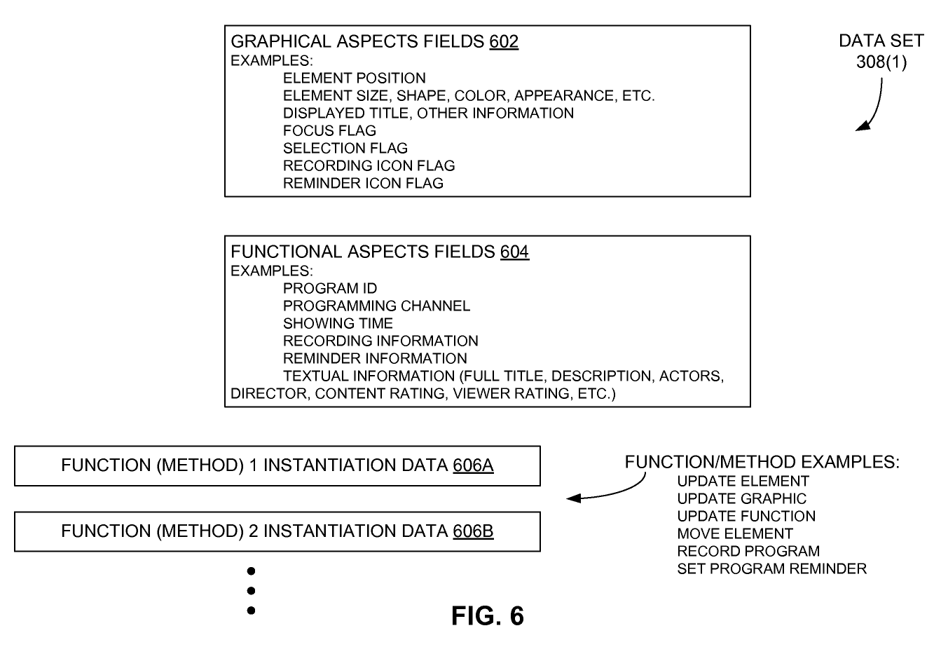

FIG. 6 provides a logical view of one of the program element data sets 308 of FIG. 5. The program element data set 308 includes data associated with or representative of the program element 408 associated therewith. In the specific example of FIG. 6, the data are divided among graphical aspect fields 602 associated with the associated program element 408, and functional aspect fields 604 of the element 408. Such a distinction between these two types of data may not be facilitated in other implementations, however. In another arrangement, the two types of fields 602, 604 may be viewed as separate data sets or structures.

The fields 302 of the data set 308 describe or specify one or more graphical aspects of the program element 408 associated with that data set 308. Such aspects may include, but are not limited to, the position of the element 408 within the EPG graphical display 400, as well as the size, shape, color, and/or other visual appearance of the element 408. The graphical aspects of the element 408 may also include textual information, such as the displayed title, description, and other relevant information of the program as represented graphically by the program element 408. Other information in the graphical aspect fields 602 may include indications as to whether the program element 408 is a focused or selected element 408, and whether the set-top box 300 is configured to record or provide a reviewing reminder for the associated program.

In contrast to the graphical aspect fields 302, the functional aspect fields 604 of the same data set or structure 602 may provide more functional or descriptive information regarding the program itself. Information stored in the functional aspects field 604 may include, but is not limited to, a program event identifier uniquely identifying the associated program, the channel carrying the program, the time at which the program airs, the complete title of the program, and information specifically related to the program, such as a textual description, the actors and director involved, content and viewer ratings, and the like. Also included in the functional aspect fields 604 may be information regarding any reminder or recording settings involving the program. Other functional or descriptive information involving the program may be included as well.

Based on the above description of the graphical aspects fields 602 and the functional aspect fields 604, some information may be duplicated therebetween, as some of the information relating to the functional aspects of the program may be represented graphically in the associated program element 408. As a result, dividing the information represented in the two set of fields 602, 604 as depicted in FIG. 6 may result in more space being consumed in the data storage 304 than is necessary.

Each of the data sets 308 is associated with a separate function or “method” configured to modify that data set 308. More specifically, when such a function is executed, the data within the graphical aspect fields 602 may be modified, thus modifying a graphical aspect of the graphical element 408 associated with the data set 308. In the embodiment of FIG. 3, each of these functions or methods is executable by the control circuitry 306 in response to some input or initiating signal, which is discussed more completely below. Additionally, each of these functions may also be configured to modify the functional aspect fields 604 of its associated data set 308, thus altering a functional aspect of the set-top box 300 related to the program element 408 of the associated data set 308.

In one implementation, exactly one separate function may be associated with each of the data sets 308 to alter the fields 602, 604 of that data set 308. Such a function may be, for example, an “update element” function or method, as noted in FIG. 6. In another embodiment, separate functions are employed for each of the fields 602, 604, such as the separate “update graphic” and “update function” methods listed in FIG. 6. In yet another example, any number of multiple functions or methods may be associated with each of the data sets 308, with each of the multiple functions being applied to a specific set of information within either or both of the types of fields 602, 604 of the corresponding data set 308. Examples of such functions may include a “move element” function, a “set program reminder” function, a “record program” function, and the like. Other ways of apportioning different tasks among one or more functions or methods may be undertaken in other implementations.

Generally, regardless of the number of program elements 408 and associated data sets 308 being employed, a single description of the one or more different functions associated with any of the program elements 408 may be provided in firmware or software associated with the control circuitry 306. This firmware or software may reside within a memory, such as flash memory, associated with the control circuitry 306, within the data storage 304, or within another type of memory or data storage not explicitly depicted in FIG. 3. Thus, to allow independent execution of each of the functions for each of the separate data sets 308, each data set 308 may include or be coupled with one or more sets of function instantiation data 606A, 606B, as shown in FIG. 6. Each function instantiation data set 606 may include information regarding the execution status of the function, such as a program counter, variable values, and similar information. As a result, the functions associated with each of the program elements 408 may facilitate modification of the graphical aspects of each of the program elements 408, as well as concurrent modification of functional aspects of the set-top box 300 relating to those program elements 408, concurrently or simultaneously. In one implementation, each function associated with a data set 308 corresponds to at least one function instantiation 606.

Each of the functions or methods described above may be initiated by way of a signal generated by the control circuitry 306. Such a signal may indicate some change in the set-top box 300, or some user input 318 into the set-top box 300, that possibly affects the graphical and/or functional aspects of one or more of the program elements 408 of FIG. 4. The control circuitry 306 may generate a signal in response to a number of other events or activities generated within the set-top box 300 or externally thereto.

One source of the signal may be a clock signal indicating a current time value, such as the current time in the time zone in which the set-top box 300 is located. Such a signal may be issued periodically, such as once per minute, and may be sourced by the control circuitry 306 within the set-top box 300, provided as data along with the audio/video programs or EPG data 315 received at the input interface 310. In response to the signal being generated, the control circuitry 306 may initiate a function associated with some or all of the program elements 308. Each of these functions may then separately determine whether the change in the current time warrants a change in graphical position or appearance of its associated program element 308. For example, if the current time indicates that the time associated with the program elements 408 at extreme left end of the program element grid 410 are no longer being shown, the function associated with each of the program elements 408 of the grid 410 may cause its associated program element 408 to be shifted to the left. As a result of the collective action of the initiated functions, all of the program elements 408 are shifted left, with some program elements 408 at the left end being removed from the grid 410, and some new ones being inserted into the right end of the grid 410. In addition, the time elements 406 located along the upper edge of the grid 410 may be shifted in a similar fashion, with each of the time elements 406 having its own data set 308 and corresponding functions or methods.

Similar shift movements may be initiated by way of the user input 318 received at the user interface 312. For example, user navigation of the EPG graphical display 400 may cause similar function activity regarding the shifting of the program elements 408. More specifically, navigation of the grid 410 to the left or right may result in corresponding shift signals, which in turn initiate the functions of the program elements 408 to horizontally shift the program elements 408 and the time elements 406 as described above. Similarly, navigation in the up or down direction results in vertical shift signals, which cause each function to shift its corresponding program element 408 or channel element 404 in a corresponding manner. Presuming the use of a program element grid buffer 420, as discussed above, program elements 408 occupying the buffer 420 may also be shifted within the buffer 420, as well as to or from the visible grid 410.

User navigation of the graphical display 400 may also cause a change in focus from one program element 408 to another. As mentioned above, a focused element 408 may be highlighted, outlined, or emphasized graphically in some other manner compared to the remaining program elements 408 of the grid 410. Navigation at one of the edges of the grid 410 may also initiate the signals described above that cause movement of all of the program elements 408. If, instead, the user navigation occurs within the edges of the grid 410, thus not causing a shift in location of the program elements 408, only the signal relating to a change in focus will be generated, causing the appearance of the two program elements 408 involved (i.e., the element 408 previously focused, and the element 408 newly focused) to be altered by way of their separate associated functions.

Another user input 318 causing graphical changes in at least one program element 408 is the selection of a currently-focused element 408. In one implementation, this selection may cause expansion or enlargement of the selected program element 408, along with additional information regarding the associated program, such as the program description, to be displayed. In that case, the corresponding selection signal generated by the control circuitry 306 may cause only the currently-focused program element 408 to be altered in terms of size, location, information presented, and the like. In another embodiment, icons 412 within a program element 408, as depicted in FIG. 4A, may be individually selected. Under those circumstances, the icons 412 may themselves be embodied as separate graphical elements, each with its own data set and associated methods.

User input 318 other than navigation input may also influence either or both of the graphical and functional aspects of one or more program elements 408. For example, the control circuitry 306 may respond to a user indicating a recording operation of a currently-focused or currently-selected program element 408 by generating a signal indicating the user operation. In response to the signal, the function of the affected program element 408 may then configure the set-top box 300 to record the program represented by the element 408, and further alter the element 408 graphically, such as by adding an icon 412 indicating that the program is set to be recorded. Other functional aspects of the corresponding program, such as setting a reminder for the user to view the program, may be addressed in such as manner.

Other inputs received by the set-top box 300 not related to the user input 318 may also initiate signals to be processed by one or more functions associated with the various program elements 408. For example, updates to the EPG data 315 received at the input interface 310, such as changes to the airing channel or showing time of one or more audio/video programs, may cause graphical and/or functional changes to the fields 602, 604 of the corresponding program elements 408. Such changes may be effected by way of one or more signals generated by the control circuitry 306 being directed to the functions of the program elements 408 involved.

In some implementations, any signal generated by the control circuitry 306 may be directed to the function of each program element 408. In that case, the function would be responsible for determining whether any action or changes with respect to the fields 602, 604 of the corresponding data set 308, thus affecting the graphical or functional aspects of the associated program, are necessary. Configuring the set-top box 300 in such a manner reduces or eliminates any requirement to direct the signals to functions of specific program elements 408.

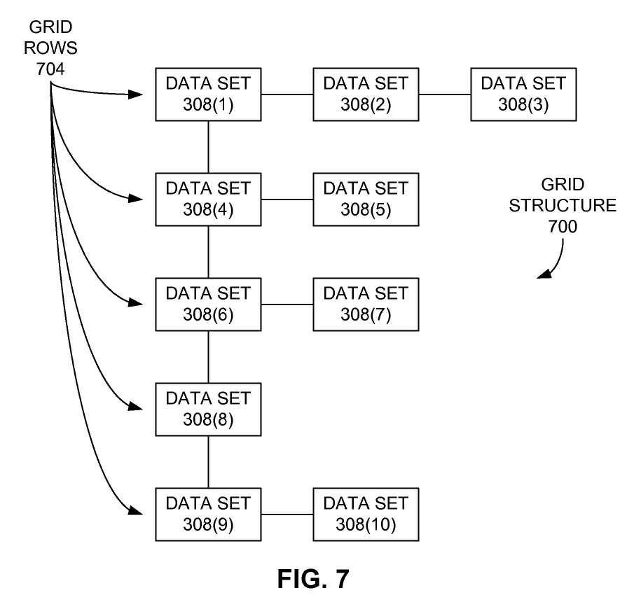

In other embodiments, the generated signals may be directed to specific groups of functions of program elements 408, depending on the nature of the signal, the current state of the various elements 408, and/or other factors. To this end, the data sets 308 of the program elements 408 may be organized to form a larger data structure describing a logical or graphical relationship between the elements 408. In the specific case of the program element grid 410 of FIG. 4A, the data sets 308 of the program elements 408 may be organized in rows 704, as depicted in FIG. 7, to form a grid structure 700. In one example, the program elements 408 may be inserted into an array, be linked by way of pointers, or otherwise coupled in some logical manner. As a result, signals affecting a particular element 408, and particular row of elements 408, or some other grouping of elements 408, may be directed specifically to those elements 408 by way of the grid structure 700. Other structures describing some relationship between the various elements 408 may be used in other implementations.

At least some embodiments as described herein facilitate management of a graphical display incorporating individual graphical elements by way of generating a separate data set and associated function or method with each element, thus allowing each element to alter or modify various graphical and functional aspects concerning that element independently of all other graphical elements. Such management potentially reduces the overall complexity of any graphical or functional manipulation of the elements, as well as the objects or entities the elements represent, especially when a large number of elements is involved. Further, individualized management of the graphical elements may more easily take advantage of any parallel processing opportunities that may exist within the electronic device involved.

While several embodiments of the invention have been discussed herein, other implementations encompassed by the scope of the invention are possible. For example, while various embodiments have been described primarily within the context of an EPG graphical display, other displays incorporating multiple graphical elements that are generated by a television set-top box may be managed according to the concepts explicated above. More generally, while this disclosure focuses upon television set-top boxes, other electronic devices, such as computers, mobile communication devices, PDAs, and the like, capable of generating a display involving multiple graphical elements may benefit from application of the various principles presented herein. In addition, aspects of one embodiment disclosed herein may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims and their equivalents.

What is claimed is:

1. A method of managing a graphical display incorporating individual graphical elements, the method comprising:
at control circuitry of an electronic device, creating in data storage a data set for each of the graphical elements, wherein each of the data sets describes a graphical feature of the associated graphical element;
at the control circuitry, associating a separate function with each of the data sets, wherein each function is configured to modify the associated data set to alter the graphical feature of the associated graphical element;
at the control circuitry, generating a signal influencing the graphical display;
at the control circuitry, initiating the function associated with each of at least one of the data sets in response to the signal; and
at the control circuitry, transferring the graphical display to an output device for presentation to a user.

2. The method of claim 1, wherein:
the graphical feature of each of the graphical elements comprises at least one of a location, a size, a color, and a visual appearance of the associated graphical element within the graphical display.

3. The method of claim 1, wherein:
the electronic device comprises a television programming receiver;
the graphical display comprises an electronic program guide display comprising information concerning a plurality of television programming events; and
each of the graphical elements is associated with a separate one of the television programming events.

4. The method of claim 3, wherein:
each of the television programming events is identified with a programming channel and a showing time.

5. The method of claim 3, wherein:
the graphical feature of each of the graphical elements comprises at least one of textual information related to the television programming event of the associated graphical element, and non-textual information related to the television programming event of the associated graphical element.

6. The method of claim 3, wherein:
the signal influencing the graphical display indicates one of a change in a time value, a shift of the graphical display, a change of focus of one of the graphical elements, and a change of a selection of one of the graphical elements.

7. The method of claim 3, wherein:
at least one of the shift of the graphical display, the change of focus of one of the graphical elements, and the change of the selection of one of the graphical elements is initiated by user input to the electronic device.

8. The method of claim 1, further comprising:
at the control circuitry, creating a second data set for each of the graphical elements, wherein each of the second data sets denotes a functional aspect of the electronic device related to the associated graphical element;
at the control circuitry, associating a second function with each of the second data sets, wherein the second function is configured to modify the functional aspect of the electronic device related to the associated graphical element;
at the control circuitry, generating a second signal associated with the graphical display; and
at the control circuitry, initiating the second function associated with each of the at least one of the graphical elements in response to the second signal.

9. The method of claim 8, wherein:
the second function is further configured to modify the first data set of each of the at least one of the graphical elements.

10. The method of claim 8, wherein:
the electronic device comprises a television programming receiver;
the graphical display comprises an electronic program guide display; and
each of the graphical elements is associated with a television programming event.

11. The method of claim 10, wherein:
for each of the graphical elements, the functional aspect of the electronic device related to the graphical element comprises at least one of displaying, recording, and setting a timer to record the television programming event associated with the graphical element.

12. The method of claim 1, wherein:
the graphical elements are represented in a data structure representing one of a graphical relationship and a logical relationship between the graphical elements within the graphical display; and
initiating the function associated with each of the at least one of the data sets in response to the signal is based upon the data structure.

13. A computer-readable data storage medium having encoded thereon instructions executable by a processor of an electronic device to perform a method of managing a graphical display incorporating individual graphical elements, the method comprising:
creating a data set for each of the graphical elements, wherein each of the data sets describes a graphical feature of the associated graphical element;
associating a separate function with each of the graphical elements, wherein each function is configured to modify the associated data set to alter the graphical feature of the associated graphical element;
generating a signal influencing the graphical display;
initiating the function associated with each of at least one of the data sets in response to the signal; and
transferring the graphical display to an output device for presentation to a user.

14. An electronic device, comprising:
an output interface configured to transfer a graphical display to an output device for presentation to a user;
data storage configured to store a plurality of data sets, wherein each of the data sets describes a graphical feature of a separate one of a plurality of graphical elements of the graphical display; and
control circuitry configured to:
create each of the data sets in the data storage;
associate a separate function with each of the data sets, wherein each function is configured to modify the associated data set to alter the graphical feature of the associated graphical element;
generate a signal influencing the graphical display;
initiate the function associated with each of at least one of the data sets in response to the signal; and
transfer the graphical display to the output device via the output interface.

15. The electronic device of claim 14, wherein:
the graphical feature of each of the graphical elements comprises at least one of a location, a size, a color, and a visual appearance of the associated graphical element within the graphical display.

16. The electronic device of claim 14, further comprising:
an input interface configured to receive television programming comprising a plurality of television programming events;
wherein the graphical display comprises an electronic program guide display providing information concerning the plurality of television programming events; and
wherein each of the graphical elements is associated with a separate one of the television programming events.

17. The electronic device of claim 16, wherein:
each of the television programming events is identified with a programming channel and a broadcast time.

18. The electronic device of claim 14, wherein:
the signal influencing the graphical display indicates one of a change in a time value, a shift of the graphical display, a change of focus of one of the graphical elements, and a change of a selection of one of the graphical elements.

19. The electronic device of claim 18, further comprising:
a user interface configured to receive user input;
wherein at least one of the shift of the graphical display, the change of focus of one of the graphical elements, and the change of the selection of one of the graphical elements is initiated by the user input received by way of the user interface.

20. The electronic device of claim 14, wherein the control circuitry is further configured to:
create a second data set in the data storage for each of the graphical elements, wherein each of the second data sets denotes a functional aspect of the electronic device related to the associated graphical element;
associate a second function with each of the second data sets, wherein the second function is configured to modify the functional aspect of the electronic device related to the associated graphical element;
generate a second signal associated with the graphical display; and
initiate the second function associated with each of the at least one of the graphical elements in response to the second signal.
